(19) United States
(12) Patent Application Publication
(10) Pub. No.: US 2025/0330430 A1
(43) Pub. Date: Oct. 23, 2025

(54) ELECTRICAL INTERFACE MODULE

(71) Applicant: HISENSE BROADBAND MULTIMEDIA TECHNOLOGIES CO., LTD., Qingdao (CN)

(72) Inventors: Liangliang ZHANG, Qingdao (CN); Yuqing HONG, Qingdao (CN); Jing WANG, Qingdao (CN)

(21) Appl. No.: 19/253,393

(22) Filed: Jun. 27, 2025

Related U.S. Application Data
(63) Continuation of application No. PCT/CN2023/095164, filed on May 19, 2023.

(30) Foreign Application Priority Data
Jan. 19, 2023 (CN) 202310077024.6
Jan. 19, 2023 (CN) 202310080290.4

(51) Int. Cl. H04L 49/111

(52) U.S. Cl. CPC H04L 49/111

(57) ABSTRACT

An electrical interface module comprises a circuit board, a network port terminal, a PHY chip and an MCU arranged on the circuit board. One end of the circuit board is disposed with a gold finger comprising an I2C pin and a multiplexing pin. The PHY chip comprises a status register. One end of the MCU can receive a command from a host device through the I2C pin, the other end thereof is connected to the PHY chip to obtain the status register value and thus send a corresponding level signal to the multiplexed pin. The function configuration register in the MCU is configured to store register value corresponding to the command from the host device, and performs corresponding function configuration on the multiplexed pin based on the register value to obtain link status of the network port terminal based on the level signal of the multiplexed pin.

This disclosure is a continuation of PCT/CN2023/095164 filed on May 19, 2023, which claims priority to applications No. 202310080290.4 filed on Jan. 19, 2023, and No. 202310077024.6 filed on Jan. 19, 2023 with the China National Intellectual Property Administration (CNIPA), the entire disclosures of which are incorporated herein by reference.

### FIELD OF THE INVENTION

The present disclosure relates to the field of optical communication technology, and particularly to an electrical interface module.

### BACKGROUND OF THE INVENTION

As an optical-electrical conversion module, the electrical interface module is widely used. For example, in a host device such as an optical network unit, the electrical interface module is used to connect a network cable for electrical signal transmission. The circuit board of the electrical interface module is provided with a network port terminal and a gold finger. When the electrical interface module is used on a host device such as an optical network unit, the gold finger of the electrical interface module is electrically connected with a circuit board in a host device such as an optical network unit, and an external network cable is connected to the network port terminal through a connector.

### SUMMARY OF THE INVENTION

The electrical interface module provided in the present disclosure comprises a circuit board, a network port terminal, a PHY chip and an MCU. One end of the circuit board is disposed with a gold finger, which comprises an I2C pin and a multiplexed pin. The network port terminal is electrically connected to the circuit board and configured to transmit a signal via a network cable. The PHY chip is arranged on the circuit board, comprising a status register configured to store a status register value corresponding to a link status of the network port terminal. The MCU is arranged on the circuit board, wherein one end of the MCU is connected to the I2C pin and the multiplexed pin, and can receive a command from a host device through the I2C pin; the other end of the MCU is connected to the PHY chip; and the MCU comprises therein with a function configuration register configured to store a register value corresponding to the command from the host device. The MCU is configured to perform corresponding function configuration on the multiplexed pin based on the register value from the function configuration register, and in a case that the multiplexed pin has a network port status indication function, send a corresponding level signal to the multiplexed pin by accessing the status register value, so as to obtain the link status of the network port terminal based on the level signal; or, in a case that the multiplexed pin has both an RX_LOS function and an network port status indication function, send a corresponding level signal to the multiplexed pin by accessing and obtaining the status register value, so as to obtain an RX_LOS state of a received signal and the link status of the network port terminal based on the level signal.

### BRIEF DESCRIPTION OF THE DRAWINGS

The accompanying drawings to be used in some embodiments of the present disclosure are described briefly below so as to more clearly describe the technical solutions of the present disclosure. Apparently, the accompanying drawings described below are only those of some embodiments of the present disclosure, and for those skilled in the art, other drawings may also be derived from these accompanying drawings. In addition, the accompanying drawings as described below may be regarded as schematic diagrams and are not intended to limit the actual size of the product, the actual process of the method, or the actual timing of the signal involved in the disclosed embodiments.

FIG. 1 is a partial structural diagram of an optical communication system according to some embodiments of the present disclosure;

FIG. 2 is a structural schematic diagram of an electrical interface module according to some embodiments of the present disclosure;

FIG. 3 is a partially exploded view of an electrical interface module according to some embodiments of the present disclosure;

FIG. 4 is an assembly schematic diagram of a circuit board and a network port terminal in an electrical interface module according to some embodiments of the present disclosure;

FIG. 5 is a structural schematic diagram of a circuit board in an electrical interface module according to some embodiments of the present disclosure;

FIG. 6 is a circuit schematic diagram of an electrical interface module according to some embodiments of the present disclosure;

FIG. 7 is a circuit block diagram of an electrical interface module according to some embodiments of the present disclosure;

FIG. 8 is a structural schematic diagram of a lower shell part in an electrical interface module according to some embodiments of the present disclosure;

FIG. 9 is an assembly schematic diagram of a lower shell part, a circuit board and a network port terminal in an electrical interface module according to some embodiments of the present disclosure;

FIG. 10 is a first assembly schematic diagram of a cover plate and an unlocker in an electrical interface module according to some embodiments of the present disclosure;

FIG. 11 is a second assembly schematic diagram of a cover plate and an unlocker in an electrical interface module according to some embodiments of the present disclosure;

FIG. 12 is an assembly schematic diagram of a lower shell part, a circuit board, a cover plate and an unlocker in an electrical interface module according to some embodiments of the present disclosure;

FIG. 13 is an assembly schematic diagram of a lower shell part, a circuit board, a cover plate, an unlocker and a handle of an electrical interface module according to some embodiments of the present disclosure.

### DETAILED DESCRIPTION OF THE EMBODIMENTS

Technical solutions of some embodiments of the present disclosure are described clearly and in detail with reference to the accompanying drawings below. Obviously, these embodiments are merely some, but not all, of the embodiments of the present disclosure. All other embodiments obtained by those skilled in the art based on the embodiments of this disclosure fall within the protection scope of this disclosure.

The term “comprise” and other forms thereof such as the third-person singular form “comprises” and the present participle form “comprising” should be construed as open and inclusive, i.e., “including, but not limited to”, throughout the description and the claims unless the context indicates otherwise. In the description, terms such as “one embodiment”, “some embodiments”, “exemplary embodiments”, “example”, “specific example”, or “some examples” are intended to indicate that specific features, structures, materials, or characteristics related to the embodiment or example are included in at least one embodiment or example of the present disclosure. The schematic references of the above terms do not necessarily refer to the same embodiment(s) or example(s). Furthermore, the specific features, structures, materials, or characteristics may be included in any one or more embodiments or examples in any appropriate manner.

Hereinafter, the terms “first” and “second” are used for descriptive purposes only, and are not to be construed as indicating or implying the relative importance or implicitly indicating the number of indicated technical features. Thus, features defined as “first” and “second” may explicitly or implicitly include one or more of the features. In the description of the embodiments of the present disclosure, the term “a plurality of”' means two or more.

In the description of some embodiments, the terms “coupled” and “connected” and their extensions may be used. For example, the term “connected” may be used in the description of some embodiments to indicate that two or more components are in direct or indirect physical or electrical contact with each other. For another example, the term “coupled” may be used in the description of some embodiments to indicate that two or more components are in direct or indirect physical or electrical contact. However, the term “coupled” or “communicatively coupled” may also mean that two or more components are not in direct contact with each other, but still cooperate or interact with each other. The embodiments disclosed herein are not necessarily limited to the contents herein.

The phrase “at least one of A, B and C” has the same meaning as the phrase “at least one of A, B or C”, and they both include the following combinations of A, B and C: only A, only B, only C, a combination of A and B, a combination of A and C, a combination of B and C, and a combination of A, B and C.

The phrase “A and/or B” includes the following three combinations: only A, only B, and a combination of A and B.

The use of “adapted to” or “configured to” herein means an open and inclusive language, which does not exclude devices that are adapted to or configured to perform additional tasks or steps.

The term “about”, “substantially” or “approximately” as used herein includes a stated value and an average value within an acceptable range of deviation of a particular value determined by a person of ordinary skill in the art, considering measurement in question and errors associated with measurement of a particular quantity (i.e., limitations of a measurement system).

Technical solutions of some embodiments of the present disclosure are described clearly and in detail with reference to the accompanying drawings below. Obviously, these embodiments are merely some, but not all, of the embodiments of the present disclosure. All other embodiments obtained by those skilled in the art based on the embodiments of this disclosure fall within the protection scope of this disclosure.

In optical communication system, an optical signal is employed to carry information to be transmitted, and the optical signal carrying the information is transmitted to an information processing device such as a computer through an information transmission device such as an optical fiber or an optical waveguide to complete transmission of the information. Since a light has a characteristic of passive transmission when being transmitted through the optical fiber or the optical waveguide, low-cost and low-loss information transmission may be achieved. In addition, the signal transmitted by an information transmission device such as an optical fiber or an optical waveguide is an optical signal, while a signal that can be identified and processed by an information processing device such as a computer is an electrical signal. Therefore, in order to establish an information connection between an information transmission device such as an optical fiber or an optical waveguide and an information processing device such as a computer, mutual conversion between an optical signal and an electrical signal is required.

An electrical interface module is provided to perform mutual conversion between the optical signal and the electrical signal in the field of optical communication technology. The electrical interface module comprises an optical interface and an electrical interface. Optical communication between the electrical interface module and an information transmission device, such as an optical fiber or an optical waveguide, is achieved through the optical interface. Electrical connection between the electrical interface module and an optical network unit (e.g., an optical modem) is achieved through the electrical interface. The electrical connection is mainly to achieve power supply, transmission of an I2C (inter integrated circuit) signal, transmission of a data information, grounding and the like. The optical network unit transmits an electrical signal to an information processing device such as a computer through a network cable or wireless fidelity technology (Wi-Fi).

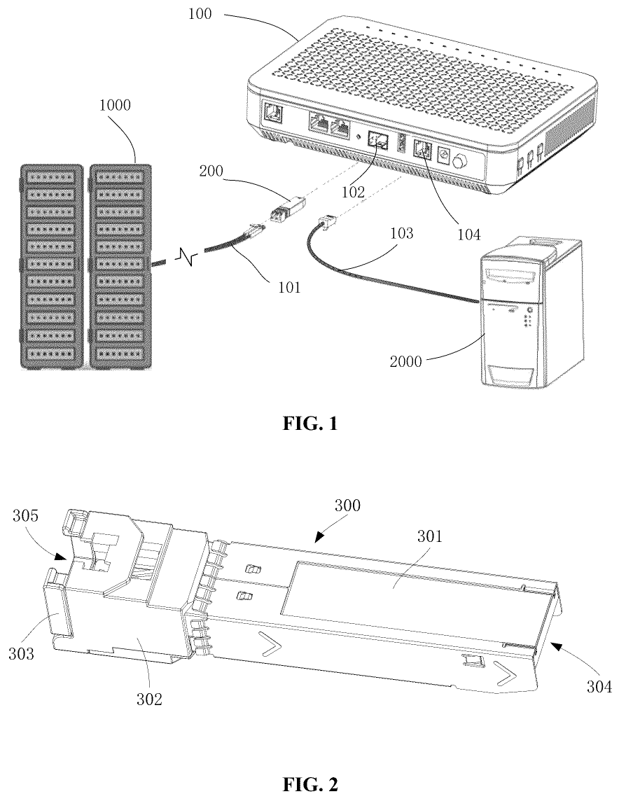

FIG. 1 is a partial structural diagram of an optical communication system according to some embodiments of the present disclosure. As shown in FIG. 1, the optical communication system comprises a remote information processing device 1000, a local information processing device 2000, a host computer 100, an optical module 200, an optical fiber 101 and a network cable 103.

One end of the optical fiber 101 extends toward the remote information processing device 1000, and the other end of the optical fiber 101 is connected to the optical module 200 via the optical port of the optical module 200. The optical signal can undergo total internal reflection within the optical fiber 101, and the propagation in the total internal reflection direction of the optical signal can maintain nearly the original optical power. The optical signal may undergo multiple total internal reflections within the optical fiber 101, in order to transmit the optical signal from the remote information processing device 1000 to the optical module 200, or transmit the optical signal from the optical module 200 to the remote information processing device 1000. This enables long-distance, low-power-loss information transmission.

The optical communication system may comprise one or more optical fibers 101, wherein each optical fiber 101 is either detachably or fixedly connected to the optical module 200. The host computer 100 is configured to provide a data signal to the optical module 200, receive a data signal from the optical module 200, or monitor or control the operational status of the optical module 200.

The host computer 100 comprises a housing which is substantially in a cuboid shape, and an optical module interface 102 disposed on the housing. The optical module interface 102 is configured to access the optical module 200, enabling the host computer 100 to establish a unidirectional/bidirectional electrical signal connection with the optical module 200.

The host computer 100 further comprises an external electrical interface, and the external electrical interface can be connected to an electrical signal network. For example, the external electrical interface comprises a universal serial bus (USB) interface or a network cable interface 104, and the network cable interface 104 is configured to access the network cable 103, so that the host computer 100 can establish a unidirectional/bidirectional electrical signal connection with the network cable 103. One end of the network cable 103 is connected to the local information processing device 2000, and the other end of the network cable 103 is connected to the host computer 100, so that an electrical signal connection is established between the local information processing device 2000 and the host computer 100 through the network cable 103. For example, a third electrical signal originating from the local information processing device 2000 is transmitted to the host computer 100 via the network cable 103. The host computer 100 generates a second electrical signal based on the third electrical signal. The second electrical signal from the host computer 100 is then transmitted to the optical module 200, where it is converted into a second optical signal. This second optical signal is subsequently transmitted to the remote information processing device 1000 in the optical fiber 101. For example, the first optical signal from the remote information processing device 1000 propagates through the optical fiber 101, the first optical signal from the optical fiber 101 is transmitted to the optical module 200, the optical module 200 converts the first optical signal into a first electrical signal, the optical module 200 transmits the first electrical signal to the host computer 100, the host computer 100 generates a fourth electrical signal according to the first electrical signal, and the fourth electrical signal is transmitted to the local information processing equipment 2000. It should be noted that the optical module is a tool to realize the mutual conversion of the optical signal and the electrical signal. During the above-mentioned conversion process between the optical signal and the electrical signal, the information content remains unchanged, while an encoding/decoding scheme of the information may be modified.

In addition to an optical network unit, the host computer 100 also comprises an optical line terminal (OLT), an optical network terminal (ONT), or a data center server, etc.

In order to facilitate the access of the network cable 103, the network cable interface 104 of the host computer 100 comprises an electrical interface module. The electrical interface module is provided with a network port terminal, and the network port terminal is connected through the connector of the network cable 103, so that the network cable 103 is inserted into the network cable interface 104. In some embodiments, the electrical interface module is not only used for the host computer 100, but can also be used for a host device such as a router and a switch.

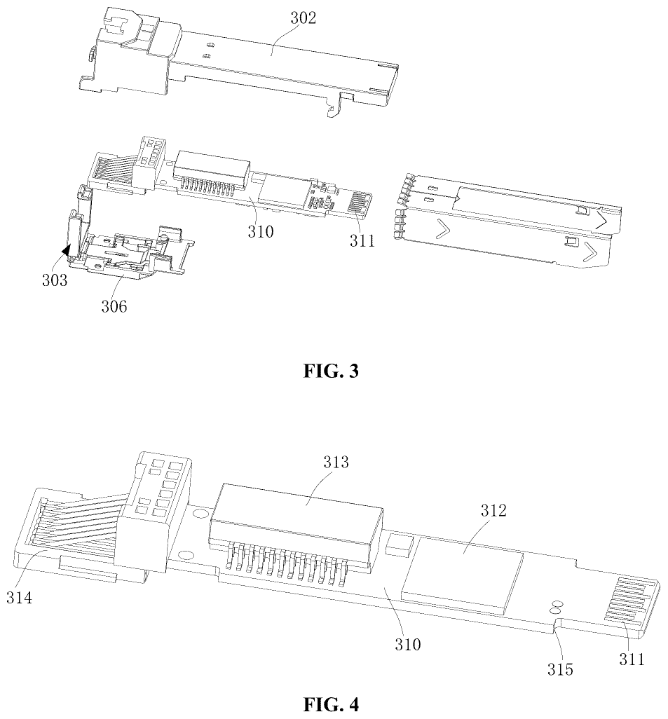

FIG. 2 is a structural schematic diagram of an electrical interface module according to some embodiments of the present disclosure, and FIG. 3 is a partially exploded view of an electrical interface module according to some embodiments of the present disclosure. As shown in FIG. 2 and FIG. 3, the electrical interface module 300 comprises a shell, a circuit board 310 arranged within the shell and components electrically connected to the circuit board 310.

The shell comprises an upper shell part 301 and a lower shell part 302, and the upper shell part 301 covers on the lower shell part 302 to form the shell with two openings. An outer contour of the shell may be in a cuboid shape.

In some embodiments of the present disclosure, the lower shell part 302 comprises a bottom plate and two lower side plates located on opposite sides of the bottom plate and disposed perpendicular to the bottom plate; the upper shell part 301 comprises a cover plate covering on the two lower side plates of the lower shell part 302 to form the shell.

In some embodiments, the lower shell part 302 comprises a bottom plate and two lower side plates located on opposite sides of the bottom plate and disposed perpendicular to the bottom plate. The upper shell part 301 comprises a cover plate and two upper side plates located on opposite sides of the cover plate and disposed perpendicular to the cover plate. The upper and lower side plates are configured to interlock, thereby enabling the upper shell part 301 to cover on the lower shell part 302.

The direction of a connecting line between an opening 304 and an opening 305 may either align with or deviate from the length direction of the electrical interface module 300. For example, the opening 304 is located at an end of the electrical interface module 300 (right end of FIG. 2), and the opening 305 is also located at an end of the electrical interface module 300 (left end of FIG. 2). Alternatively, the opening 304 is located at the end of the electrical interface module 300, and the opening 305 is located at the side of the electrical interface module 300. The opening 304 is an electrical interface, and a gold finger of the circuit board 310 extends from the electrical interface to insert into the host computer 100. The opening 305 is an optical interface, which is configured to access an external network cable 103 so that the network cable 103 is connected to a network port terminal inside the electrical interface module 300.

The assembly mode of combining the upper shell part 301 and the lower shell part 302 facilitates the installation of the circuit board 310 and other components into the shell, and the upper shell part 301 and the lower shell part 302 provide encapsulation and protection for these devices. In addition, when assembling the circuit board 300 and other devices, this assembly mode facilitates the arrangement of positioning components, heat dissipation components and electromagnetic shielding components of these devices, which is conducive to implementation of automated production.

In some embodiments, the upper shell part 301 and the lower shell part 302 are generally made of a metallic material, which facilitates electromagnetic shielding and heat dissipation.

In some embodiments, the electrical interface module 300 further comprises an unlocking component 303 located outside of the shell thereof, and the unlocking component 303 is configured to achieve or release a fixed connection between the electrical interface module 300 and the host computer.

By way of example, the unlocking component 303 is located on outer walls of the two lower side plates of the lower shell part 302, and includes an engagement component that is matched with the cage of the host computer 100. When the electrical interface module 300 is inserted into the cage of the host computer 100, the electrical interface module 300 is fixed in the cage of the host computer 100 via the engagement component of the unlocking component 303. When the unlocking component 303 is pulled, the engagement component of the unlocking component 303 moves therewith, which in turn changes a connection relationship between the engagement component and the host computer 100 to release the engagement between the electrical interface module 300 and the host computer 100, such that the electrical interface module 300 may be drawn out of the cage of the host computer 100.

The circuit board 310 comprises circuit wires, electronic elements, chips and the like. The electronic elements and the chips are connected together through the circuit wires according to a circuit design, so as to achieve functions of power supply, electrical signal transmission, grounding and the like. The electronic elements may comprise, for example, capacitors, resistors, triodes, and metal-oxide-semiconductor field-effect transistors (MOSFETs). The chips may comprise, for example, a microcontroller unit (MCU), a clock and data recovery (CDR) chip, a power management chip, etc.

The circuit board 310 is generally a rigid circuit board which may further achieve a load-bearing function due to its hard material. For example, the rigid circuit board may stably bear the above-mentioned electronic elements and the chips. The rigid circuit board may also be inserted into the electrical connector in the cage of the host computer.

In some embodiments of the present disclosure, one end of the electrical interface module 300 is disposed with a gold finger and the other end is disposed with a network port terminal. The packaging method of the electrical interface module 300 is not limited herein. The following provides an exemplary description of the structure of the electrical interface module 300 using SFP+ (Small Form-factor Pluggable Plus) packaging as an example. By way of example, when the electrical interface module 300 employs SFP+ packaging, the interfaces of the electrical interface module 300 use SFP gold fingers and a network port terminal. The electrical interface module 300 includes an MCU chip, a PHY (Physical Layer) chip, a network port terminal and SFP+ gold fingers, which supports hot-plug capability for insertion into a SFP port of a network device such as a switch and enables data transmission via a network cable. By way of example, the network port terminal may be an RJ45 network port terminal. However, due to its unique SFP+ structure, host devices and users cannot easily obtain the operational status of the RJ45 network port terminal, so the signal transmission status cannot be obtained. The host device may, for example, include a host computer 100, a router, a switch, and so on.

To address the above-mentioned limitations, in some embodiments of the present disclosure, a specific pin (e.g., PIN8) among the SFP+ gold fingers is redefined as a network port status indication pin, and a host device can identify the link status of the RJ45 network port terminal through the status of the PIN 8, and then determine whether the product function is normal.

FIG. 4 is an assembly schematic diagram of a circuit board and a network port terminal in an electrical interface module according to some embodiments of the present disclosure, and FIG. 5 is a structural schematic diagram of a circuit board in an electrical interface module according to some embodiments of the present disclosure. As shown in FIG. 4 and FIG. 5, the circuit board 310 comprises a gold finger 311 formed on a surface of an end thereof. The gold finger 311 is composed of a plurality of independent pins. The circuit board 310 is inserted into the cage of the host device and is conductively connected to the electrical connector in the cage of the host device through the gold finger 311. The gold finger 311 may be disposed only on a surface of one side (e.g., the upper surface as shown in FIG. 4) of the circuit board 310, or be disposed on surfaces of both upper and lower sides of the circuit board 310 to adapt to occasions where a large number of pins are required. The gold finger 311 is configured to establish electrical connection with the host device to achieve power supply, grounding, transmission of an I2C signal, transmission of a data signal, etc.

In some embodiments, the gold finger 311 comprises an I2C pin, an RX_LOS (Receive Loss of Signal Alarm) pin, etc., to establish communication connection between the host device and components within the electrical interface module 300.

The circuit board 310 comprises an MCU 312, a PHY chip 313, and a network port terminal 314. The MCU 312, the PHY chip 313 and the network port terminal 314 are electrically connected to the circuit board 310 respectively, and are electrically connected to each other through the conductive traces on the circuit board 310. The network port terminal 314 can be connected and adapted to the network cable 103.

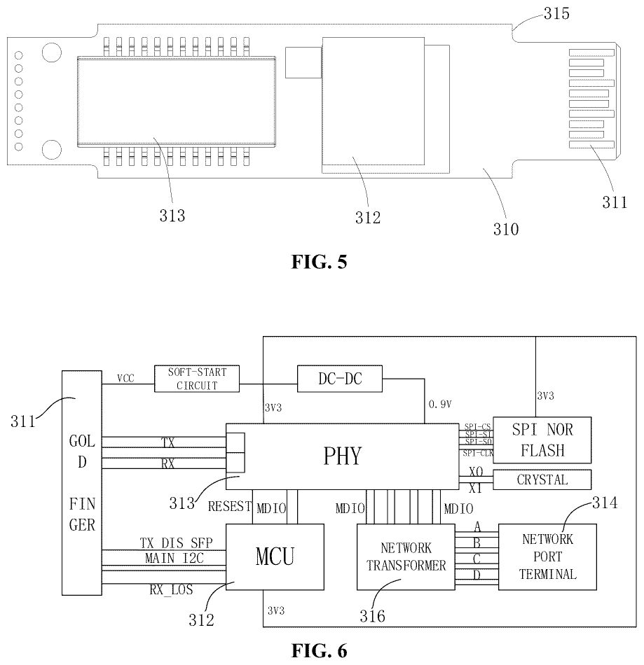

FIG. 6 is a circuit schematic diagram of an electrical interface module according to some embodiments of the present disclosure. As shown in FIG. 6, in some embodiments, the MCU 312 comprises an I2C interface, and the I2C interface is electrically connected to the I2C pin of the gold finger 311, so that I2C communication between the MCU 312 and the host device is realized. The PHY chip 313 comprises a SerDes interface. The SerDes interface of the PHY chip 313 is connected to the SerDes interface pin of the gold finger 311 through a differential signal line, and further connected to the SerDes interface of the host device through the Serdes interface pin, so that the communication connection between the PHY chip 313 and the host device is realized.

In some embodiments, after the MCU 312 is electrically connected to the gold finger 311, the host device transmits a signal to the gold finger 311, and the gold finger 311 transmits the signal to the MCU 312 through a conductive trace. The MCU 312 controls the transmission of the signal to the network port terminal 314. When the network cable 103 is inserted into the network port terminal 314, the signal is transmitted to the local information processing device 2000 through the network cable 103, so that the host device is electrically connected to the local information processing device 2000 through the electrical interface module 300.

In some embodiments, an optical module product comprises a Receive Loss of Signal Alarm (RX_LOS) pin in its interface, and the state of the RX_LOS pin is monitored in the hardware circuit design to determine whether the optical signal is lost. In Ethernet networks, when a change in the RX_LOS state is detected, an RX_LOS interrupt is immediately generated and reported to the processing system, which promptly responds and handles the RX_LOS interrupt. This method of quickly reporting an RX_LOS state change in the form of RX_LOS interrupt is one of the important mechanisms to achieve fast link switching in Ethernet implementations.

In some embodiments, one of the pins at the end of the gold finger 311 is an RX_LOS pin. By way of example, when pin 8 (hereinafter referred to as the PIN8) of the gold finger 311 is defined as an RX_LOS pin, an RX_LOS signal is transmitted through the PIN8 to indicate whether the optical signal is lost. By way of example, the level state of the PIN8 is used to determine whether the optical signal is lost, that is, whether the optical signal is received. The definition is as follows:
(1) When the PIN8 is at a high level, it indicates that the optical signal is lost (i.e., the optical signal is not received);
(2) When the PIN8 is at a low level, it indicates that the optical signal is not lost (i.e., the optical signal is received).

In some embodiments, the MCU 312 further comprises an RX_LOS interface, and the gold finger 311 comprises an RX_LOS pin (i.e., the PIN8). The RX_LOS interface is electrically connected to the RX_LOS pin through a wiring to directly indicate whether the received optical signal is normal. By way of example, when the received optical signal is not lost, RX_LOS=0; when the received signal is lost, RX_LOS=1.

In some embodiments, when the electrical interface module 300 is connected to the network cable 103, the signal transmitted by the network cable 103 is an electrical signal. Therefore, there is no need to use PIN8 to detect whether the electrical interface module 300 has received an optical signal. Instead, the PIN8 is repurposed as a network port status indication pin to monitor the link status of the network port terminal 314. In some embodiments, the electrical interface module 300 is connected to a photoelectric composite cable, and the photoelectric composite cable can transmit both an optical signal and an electrical signal, so the PIN8 is configured to monitor whether the electrical interface module 300 has received an optical signal, and simultaneously monitor the link status of the network port terminal 314.

In some embodiments, when the electrical interface module 300 is connected to the network cable 103, the signal transmitted by the network cable 103 is an electrical signal, so there is no need to use PIN8 to detect whether the electrical interface module has received an optical signal. Accordingly, the PIN8 of the gold finger 311 can be repurposed and assigned a new function, which is defined as a network port status indication pin, enabling the PIN8 to provide network port status indication, so that the host device can obtain the link status of the RJ45 network port terminal through the level state of the PIN8. By way of example, the PIN8 can be referred to as a multiplexed pin.

In some embodiments, when the electrical interface module 300 is connected to a photoelectric composite cable, the signal transmitted by the photoelectric composite cable comprises an optical signal and an electrical signal, so the PIN8 is configured to monitor the RX_LOS state of the received optical signal and the link status of the network port terminal. To achieve this, the PIN8 is assigned a new function, so that the PIN8 has both the RX_LOS function and the network port status indication function.

In some embodiments, the MCU 314 is provided with a function configuration register that stores a register value corresponding to a host device command. According to the register value in the function configuration register, the MCU 314 configures the PIN8 to have the RX_LOS function, have the network port status indication function, or have both the RX_LOS function and the network port status indication function.

In some embodiments, the above-mentioned function configuration register may include a single register or a plurality of registers, and the number of the function configuration registers is not limited in the embodiments of the present disclosure.

By way of example, when the function configuration register comprises a plurality of registers, such registers may include a first register and a second register.

In some embodiments, the register value of the first register comprises a first register value and a second register value. By way of example, the MCU 314 configures the function of the PIN8 based on the first register value, so that the PIN8 has the RX_LOS function; the MCU 314 configures the PIN8 based on the second register value, so that the PIN8 has the network port status indication function.

In some embodiments, the register value of the second register comprises a third register value and a fourth register value. By way of example, the MCU 314 configures the function of the PIN8 based on the third register value, so that the PIN8 has the RX_LOS function; the MCU 314 configures the PIN8 based on the fourth register value, so that the PIN8 pin has both the RX_LOS function and the network port status indication function.

By way of example, when the function configuration register comprises a single register, the register value of the function configuration register comprises a fifth register value, a sixth register value, and a seventh register value. The MCU 314 configures the function of the PIN8 according to the fifth register value, so that the PIN8 pin has the RX_LOS function; the MCU 314 configures the function of the PIN8 according to the sixth register value, so that the PIN8 has the network port status indication function; the MCU 314 configures the function of the PIN8 according to the seventh register value, so that the PIN8 has both the RX_LOS function and the network port status indication function.

The following takes the function configuration register, comprising a first register and a second register (e.g., an MCU 312 is provided with a first register and a second register) as an example, to provide an exemplary description of the specific implementation method of monitoring the link status of the network port terminal by repurposing the PIN8.

In some embodiments, the MCU 312 is provided with a first register configured to store different register values, where different register values correspond to different functions of the PIN8, so that the PIN8 has different function selections.

In some embodiments, the MCU 312 receives a host device command through the I2C pin, and the host device command is used to specify the function of the PIN8. By way of example, the MCU 312 stores corresponding register values in the first register according to host device commands, and performs corresponding functions on the PIN8 according to different register values, so as to realize the function selection of the PIN8 by changing the first register.

In some embodiments, when the host device needs to configure the function of the PIN8, it sends a corresponding host device command to the MCU 312 through the I2C communication bus. The MCU 312 stores different register values, such as the first register value and the second register value, in the first register according to different host device commands received, so as to indicate the function selection of the PIN8.

By way of example, when the first register stores the first register value, the PIN8 defaults to an RX_LOS pin; when the first register stores the second register value, the PIN8 is redefined as a network port status indication pin, and the function of the PIN8 is switched from transmitting the RX_LOS signal to indicating the state of the network port terminal, so that the link status of the network port terminal 314 of the electrical interface module 300 is monitored through the PIN8.

The embodiments of the present disclosure do not limit the specific values of the first register value and the second register value. The following embodiment uses “00” as the first register value and “01” as the second register value to provide an exemplary description of the working principle of the first register.

By way of example, the MCU 312 can set “00” in the first register to correspond to the RX_LOS function of the PIN8, and set “01” in the first register to correspond to the network port status indication function of the PIN8.

When the MCU 312 receives a command from the host device to configure the PIN8 as an RX_LOS pin, the MCU 312 sets the register value of the first register to the first register value “00” and feeds back the configuration result to the host device. When the MCU 312 detects that the register value of the first register is “00” by polling or other means, the PIN8 defaults to an RX_LOS pin.

When the MCU 312 receives a command from the host device to configure the PIN8 as a network port status indication pin, the MCU 312 sets the register value of the first register to the second register value “01” and feeds back the configuration result to the host device. When the MCU 312 detects that the register value of the first register is “01” by polling or other means, the PIN8 is switched to the network port status indication pin, so as to achieve the functional switching of PIN8.

In some embodiments, the first register in the MCU 312 may be a register of A2 in the MCU 312, such as B6, or alternatively, any other register inside the MCU 312.

In some embodiments, the MCU 312 further comprises an MDIO interface. The MCU 312 is connected with the PHY chip 313 through the MDIO interface to access the PHY chip 313 through the MDIO interface, thereby obtaining the operational status of the PHY chip 313. When the PIN8 is configured as a network port status indication pin, the MCU 312 outputs a level signal to the PIN8 according to the operational status of the PHY chip 313, and indicates the link status of the network port terminal 314 through the level state of the PIN8, so that the host device can obtain the link status of the network port terminal of the electrical interface module 300 according to the level state of the PIN8 at this time.

In some embodiments, when the PIN8 is configured as a network port status indication pin, and the MCU 312 sends a corresponding level signal to the PIN8 according to the operational status of the PHY chip 313, the MCU 312 can directly supply power to the PIN8, so that the PIN8 has a corresponding level value, such as a high level and a low level. Alternatively, the PIN8 is electrically connected to a power supply unit, and the MCU 312 is controllably linked to the power supply unit. In this configuration, the MCU 312 sends a corresponding control signal to the power supply unit, making the power supply unit provide a corresponding voltage to the PIN8, so that the PIN8 has a corresponding level value.

In some embodiments, the PHY chip 313 is a physical interface transceiver that implements the physical layer IEEE-802.3 standard to define the Ethernet PHY, including the MII (Media Independent Interface)/GMII (Gigabit Media Independent Interface) sublayer, the PCS (Physical Coding Sublayer), the PMA (Physical Medium Attachment) sublayer, the PMD (Physical Medium Dependent) sublayer, and the MDI (Medium Dependent Interface) sublayer.

When transmitting data, the PHY chip receives the data from the MAC (Media Access Control Address) layer, converts the parallel data into a serial data stream, encodes the data according to the coding rules of the physical layer, and then transforms it into an analog signal to transmit the data. The data reception process follows the reverse sequence.

Another important function of the PHY chip is to implement part of the functions of CSMA/CD (Carrier Sense Multiple Access with Collision Detection). It detects whether there is data in transmission on the network. The PHY chip waits if there is data in transmission. Upon detecting network idle status, it waits a random backoff period before initiating data transmission.

Since the PHY chip 313 can detect whether data is being transmitted on the network, that is, the PHY chip 313 can self-detect and obtain its own operational status, so as to obtain the link status of the network port terminal 314 in the electrical interface module 300. For example, the link status at the network port terminal 314 may include disconnected link status, connected link status, and data interaction.

In some embodiments, a status register is arranged in the PHY chip 313, and the status register is configured to store the link status of the network port terminal 314, so that the link status of the network port terminal 314 can be obtained according to the value of the status register in the PHY chip 313.

The embodiments of the present disclosure do not limit the specific values of the first, second, and third status register values stored in the status register. The following embodiment uses “00” as the first status register value, “01” as the second status register value, and “02” as the third status register value to provide an exemplary description of the working principle of the status register.

By way of example, when the status register stores the first register value “00”, it indicates that the link of the network port terminal of the electrical interface module 300 is disconnected. When the status register stores the second register value “01”, it indicates that the link of the network port terminal of the electrical interface module 300 is connected. When the status register stores the third register value “02”, it indicates that there is data interaction at the network port terminal of the electrical interface module 300.

In some embodiments, when the PIN8 is configured as the network port status indication pin, the MCU 312 accesses the PHY chip 313 through the MDIO interface to obtain the value of the status register in the PHY chip 313, and outputs a corresponding level signal to the PIN8 based on the value of the status register. By way of example, when the value of the status register in the PHY chip 313 is the first status register value, it indicates that the link of the network port terminal of the electrical interface module 300 is disconnected, and the MCU 312 outputs a first level signal to the PIN8. When the value of the status register in the PHY chip 313 is the second status register value, it indicates that the link of the network port terminal of the electrical interface module 300 is connected, and the MCU 312 outputs a second level signal to the PIN8. When the value of the status register in the PHY chip 313 is the third status register value, it indicates that there is data interaction of the network port terminal of the electrical interface module 300, and the MCU 312 outputs a third level signal to the PIN8.

In some embodiments, the first level signal is a high level signal, the second level signal is a low level signal, and the third level signal is a high-low transition pulse. The level value of the first level signal is greater than the level value of the second level signal, and the level value of the first level signal is greater than the level value of the third level signal.

By way of example, the level value of the first level signal is 2 to 3.3V, the level value of the second level signal is 0 to 0.8V, and the third level signal is a pulse signal ranging from 0 to 3.3V.

In some embodiments, the electrical interface module 300 further comprises a network transformer 316. The network transformer 316 is arranged on the circuit board 310, which is electrically connected to the network port terminal 314 and the PHY chip 313 respectively via conductive traces on the circuit board 310. By way of example, the network transformer 316 is connected to the network port terminal 314 through four pairs of conductive traces, and the network transformer 316 is connected to the PHY chip through four pairs of MDIO interfaces, facilitating the control and adjustment of the electrical signal transmission rate.

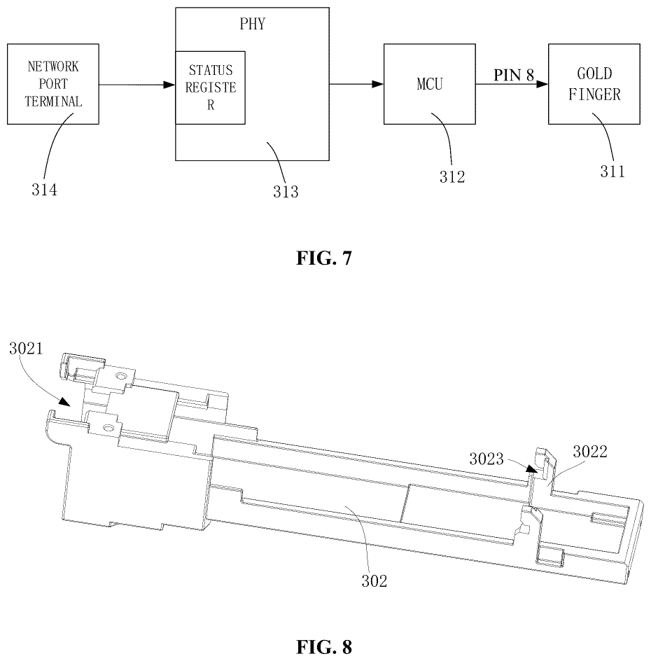

FIG. 7 is a circuit block diagram of an electrical interface module according to some embodiments of the present disclosure. As shown in FIG. 7, after the network cable 103 is inserted into the network port terminal 314 of the electrical interface module 300, the PHY chip 313 sets the value of the status register based on the link status of the network port terminal 314. The MCU 312 accesses the PHY chip 313 through the MDIO interface to obtain the value of the status register in the PHY chip 313. Then the MCU 312 outputs a corresponding level signal to the PIN8 of the gold finger 311 according to the value of the status register, so that the host device can obtain the link status of the network port terminal of the electrical interface module 300 by monitoring the level state of the PIN8, thus obtaining the data transmission status and the operational status of the electrical interface module 300.

In some embodiments, after the host device is electrically connected to the gold finger 311 of the electrical interface module 300, the host device sends a command to the MCU 312 to change the function of the PIN8 through the I2C pin on the gold finger 311, and the MCU 312 changes the value of the first register according to the command to change the function of the PIN8 of the gold finger 311 and configures it as a network port status indication pin. Then the MCU 312 accesses the PHY chip 313 through the MDIO interface to obtain the operational status of the PHY chip 313. Finally, the MCU 312 outputs a corresponding level signal to the PIN8 according to the operational status of the PHY chip 313.

In some embodiments, the host device obtains the link status of the network port terminal of the electrical interface module 300 by monitoring the level state of the PIN8. By way of example, when the host device detects that the level state of the PIN8 is the first level signal, it indicates that the link of the network port terminal 314 of the electrical interface module 300 is disconnected. When the host device detects that the level state of the PIN8 is the second level signal, it indicates that the link of the network port terminal 314 of the electrical interface module 300 is connected. When the host device detects the level state of the PIN8 is the high-low transition pulse, it indicates that there is data interaction at the network port terminal 314 of the electrical interface module 300.

In some embodiments, the operational status is visually indicated to users through LED illumination states (on/off/flashing). Therefore, an LED light may be added to the wiring connecting MCU 312 and PIN8, so that the link status of the network port terminal 314 of the electrical interface module 300 is obtained through the LED light's display state.

In some embodiments, after the host device is electrically connected to the gold finger 311 of the electrical interface module 300, the host device sends a command to the MCU 312 to configure the function of the PIN8 through the I2C pin of the gold finger 311, and the MCU 312 configures the value in the first register according to the command to switch the function of the PIN8 of the gold finger 311, thereby configuring the PIN8 as a network port status indication pin. Then the MCU 312 accesses the PHY chip 313 through the MDIO interface to obtain the operational status of the PHY chip 313. Finally, the MCU 312 outputs a corresponding level signal to the PIN8 according to the operational status of the PHY chip 313, and the LED light connected to the PIN8 is displayed according to the level state of the PIN8.

By way of example, when the host device detects the LED light in an OFF state, it indicates that the link of the network port terminal 314 is disconnected. When the host device detects the LED light in a steady ON state, it indicates that the link of the network port terminal 314 is connected. When the host device detects the LED light in a FLASHING state, it indicates that there is data interaction at the network port terminal 314.

In some embodiments of the present disclosure, by redefining the PIN8 of the SFP+ gold finger as a network port status indication pin, the MCU sends a corresponding level signal to the PIN8 according to the link status of the network port terminal 314, and indicates the link status of the electrical interface module through the level state of the PIN8. For end users, monitoring the level state of the PIN8 enables convenient identification of the link status of the RJ45 network port terminal, which improves usability. For manufacturing testing, the link status of the RJ45 network port terminal can be verified according to the level state of the PIN8, so as to determine whether the function of the product is normal.

In some embodiments, one pin of the gold finger 311 is an RX_LOS pin. By way of example, the PIN8 of the gold finger 311 may be defined as an RX_LOS pin for transmitting an RX_LOS signal to alert whether the module has received an optical signal. The PIN8 may alternatively be defined as a network port status indication pin, which outputs different level signals according to the link status of the network port terminal 314, so that the link status of the network port terminal 314 of the electrical interface module 300 is monitored according to the level state of the PIN8.

When the PIN8 is defined as an RX_LOS pin, a high level of the PIN8 indicates that no optical signal is received and a low level of the PIN8 indicates that an optical signal has been received. When the PIN8 is defined as a network port status indication pin, a high level of the PIN8 indicates that the link of the network port terminal 314 of the electrical interface module 300 is disconnected, and a low level the PIN8 indicates that the link of the network port terminal of the electrical interface module 300 is connected.

When the PIN8 is at a high level, the link of the network port terminal 314 of the electrical interface module 300 is disconnected, and the signal cannot be received. When the PIN8 is at a low level, the link of the network port terminal 314 of the electrical interface module 300 is connected, and the signal can be received. Therefore, the PIN8 can have both the RX_LOS function and the network port status indication function, so that the RX_LOS state of the optical signal and the link status of the network port terminal 314 of the electrical module can be obtained according to the level state of the PIN8.

In some embodiments, the MCU 312 is provided with a second register, which configures the PIN8 to perform different functions by storing different register values, thereby enabling the PIN8 to have different function selections. The MCU 312 receives a host device command through the I2C pin, and the host device command specifies the function of the PIN8. The MCU 312 stores a corresponding register value in the second register according to the host device command, and executes designated functions on the PIN8 according to different register values, so as to realize the function selection of the PIN8 by changing the second register.

In some embodiments, when the host device needs to define a new function of the PIN8, it sends a corresponding host device command to the MCU 312 through the I2C communication bus. The MCU 312 stores different register values in the second register, such as the third register value and the fourth register value, according to different host device commands received, so as to select the function of the PIN8 according to the register value stored in the second register.

By way of example, when a third register value is stored in the second register, the PIN8 defaults to the RX_LOS pin for detecting whether the received optical signal is lost.

By way of example, when a fourth register value is stored in the second register, the PIN8 is redefined simultaneously as an RX_LOS pin and a network port status indication pin, which is configured to detect whether the received signal is in a LOS condition and report the link status of the network port terminal 314 of the electrical interface module 300.

The embodiments of the present disclosure do not limit the specific values of the third register value and the fourth register value. The following embodiment uses “00” as the third register value and “01” as the fourth register value to provide an exemplary description of the working principle of the second register.

By way of example, the MCU 312 can set “00” in the second register to correspond to the RX_LOS function of the PIN8, and set “01” in the second register to correspond to the RX_LOS function and the network port status indication function of the PIN8.

When the MCU 312 receives a command from the host device to configure the PIN8 as an RX_LOS pin, the MCU 312 sets the register value of the second register to the third register value “00” and feeds back the configuration result to the host device. When the MCU 312 detects that the register value of the second register is “00” by polling or other means, the PIN8 is configured as an RX_LOS pin.

When the MCU 312 receives a command from the host device to configure the PIN8 as an RX_LOS pin and a network port status indication pin, the MCU 312 sets the register value of the second register to the fourth register value “01” and feeds back the configuration result to the host device. When the MCU 312 detects that the register value of the second register is “01” by polling or other means, the PIN8 is configured as an RX_LOS pin and a network port status indication pin.

After configuring the function of the PIN8 according to the host device command, the MCU 312 outputs the corresponding level signal to the PIN8 according to the operational status of the PHY chip 313, and indicates the RX_LOS state of the received signal and the link status of the network port terminal 314 according to the level state of the PIN8. The host device demodulates and separates the level signal of the PIN8 to obtain the corresponding LOS signal and the link status signal. That is, the host device can obtain the link status of the network port terminal 314 of the electrical interface module 300 and the RX_LOS state of the received signal according to the level state of the PIN8 at this time.

In some embodiments, when the PIN8 has both the RX_LOS function and the network port status indication function, the MCU 312 accesses the PHY chip 313 through the MDIO interface to obtain the value of the status register in the PHY chip 313, and outputs a corresponding level signal to the PIN8 according to the value of the status register. By way of example, when the value of the status register in the PHY chip 313 is the first status register value, it indicates that the link of the network port terminal 314 of the electrical interface module 300 is disconnected and the received signal is in a loss-of-signal condition, and the MCU 312 outputs a fourth level signal to the PIN8. When the value of the status register in the PHY chip 313 is the second status register value, it indicates that the link of the network port terminal 314 of the electrical interface module 300 is connected and the received signal is not in the loss-of-signal condition, and the MCU 312 outputs a fifth level signal to the PIN8.

In some embodiments, when the PIN8 serves as an RX_LOS pin, its level state can only be high or low. When the PIN8 serves as a network port status indication pin, the link status of the network port terminal 314 has three statuses: disconnected, connected, and data interaction. When there is data interaction at the network port terminal 314, it indicates a connected link status of the network port terminal 314 and the PIN8 is at a low level. In order to clearly indicate that there is data interaction at the network port terminal 314, that is, when the value of the status register in the PHY chip 313 is the third status register value, the MCU 312 outputs a sixth level signal to the PIN8.

In some embodiments, the fourth level signal is a high level signal, the fifth level signal is a low level signal, and the sixth level signal is a high-low transition pulse. The level value of the fourth level signal is greater than the level value of the fifth level signal, and the level value of the fourth level signal is greater than the level value of the sixth level signal.

In some embodiments, after the host device is electrically connected to the gold finger 311 of the electrical interface module 300, the host device sends a command to the MCU 312 to change the function of the PIN8 through the I2C pin on the gold finger 311. Then the MCU 312 changes the value of the second register according to the command to change the function of the PIN8 of the gold finger 311 and configures it as an RX_LOS pin and a network port status indication pin, such that the PIN8 has both the functions of indicating the link status of the network port terminal and detecting whether the received signal is in the loss-of-signal condition.

After the network cable 103 is inserted into the network port terminal 314 of the electrical interface module 300, the PHY chip 313 sets the value of the status register based on the link status of the network port terminal 314. The MCU 312 accesses the PHY chip 313 through the MDIO interface to obtain the value of the status register in the PHY chip 313. Then the MCU 312 outputs a corresponding level signal to the PIN8 according to the value of the status register, enabling the host device to obtain the link status of the network port terminal of the electrical interface module 300 and the RX_LOS state of the received signal by detecting the level state of the PIN8, so that the user can identify these states.

In some embodiments, when the host device detects that the level state of the PIN8 is high, the link of the network port terminal 314 of the electrical interface module 300 is disconnected, and the optical signal is lost. When the host computer detects that the level state of the PIN8 is low, the link of the network port terminal 314 of the electrical interface module 300 is connected, and the optical signal is not lost. When the host computer detects high-low pulse transitions on the PIN8, there is data interaction at the network port terminal 314 of the electrical interface module 300, and the optical signal is not lost.

In some embodiments, the operational status is visually indicated to users through LED illumination states (on/off/flashing). Therefore, an LED light may be added to the wiring connecting MCU 312 and PIN8, so that the link status of the network port terminal 314 of the electrical interface module 300 and the RX_LOS state of the received signal are obtained through the LED light's display state.

In some embodiments, after the host device is electrically connected to the gold finger 311 of the electrical interface module 300, the host device sends a command to the MCU 312 to change the function of the PIN8 through the I2C pin on the gold finger 311, and the MCU 312 changes the value in the second register according to the command to change the function of the PIN8 of the gold finger 311 and configures it as an RX_LOS pin and a network port status indication pin. Then the MCU 312 accesses the PHY chip 313 through the MDIO interface to obtain the operational status of the PHY chip 313. Finally, the MCU 312 outputs a corresponding level signal to the PIN8 according to the operational status of the PHY chip 313, and the LED light connected to the PIN8 is displayed according to the level state of the PIN8.

By way of example, when the host device detects the LED light in an OFF state, it indicates that the link of the network port terminal 314 of the electrical interface module 300 is disconnected, and the received optical signal is lost. When the host device detects the LED light in a steady ON state, it indicates that the link of the network port terminal 314 of the electrical interface module 300 is connected, and the received optical signal is not lost. When the host device detects the LED in a FLASHING state, it indicates that there is data interaction of the network port terminal 314 of the electrical interface module 300, and the received optical signal is not lost.

In some embodiments of the present disclosure, the PIN8 of the SFP+ gold fingers is redefined as an RX_LOS pin and a network port status indication pin, so that the PIN8 has both the RX_LOS function and the network port status indication function. The MCU sends a corresponding level signal to the PIN8 according to the link status of the network port terminal 314, and indicates the link status of the electrical interface module and the RX_LOS state of the received signal through the level state of the PIN8. For end users, the host device can identify the link status of the RJ45 network port terminal and the RX_LOS state of the received signal through the level state of the PIN8, which is convenient for the user to identify and increase convenience. For manufacturing testing, the link status of the RJ45 network port terminal and the RX_LOS state of the received signal can be verified according to the level state of the PIN8, so as to determine whether the function of the product is normal.

The following takes the function configuration register, comprising a single register, as an example to provide an exemplary description of the specific implementation method of monitoring the link status of the network port terminal by repurposing the PIN8.

By way of example, when a function configuration register comprises a single register, the MCU 314 configures the PIN8 according to the register values in the function configuration register, such as the fifth register value, the sixth register value, and the seventh register value.

The embodiments of the present disclosure do not limit the specific values of the fifth register value, the sixth register value, and the seventh register value. The following embodiment uses “00” as the fifth register value, “01” as the sixth register value and “02” as the seventh register value to provide an exemplary description of the working principle of the function configuration register.

By way of example, the MCU 314 configures the function of the PIN8 according to the fifth register value “00”, so that the PIN8 has an RX_LOS function.

The MCU 314 configures the function of the PIN8 according to the sixth register value “01”, so that the PIN8 has a network port status indication function.

The MCU 314 configures the function of the PIN8 according to the seventh register value “02”, so that the PIN8 has both the RX_LOS function and the network port status indication function.

In some embodiments, when the PIN8 has the network port status indication function, a corresponding level signal is sent to the PIN8 by accessing and obtaining the status register value, so as to obtain the link status of the network port terminal according to the level signal.

In some embodiments, when the PIN8 has both the RX_LOS function and the network port status indication function, a corresponding level signal is sent to the PIN8 by accessing and obtaining the status register value, so as to obtain the RX_LOS state of the received signal and the link status of the network port terminal according to the level signal.

By way of example, when the register value of the function configuration register is the fifth register value, if the MCU 312 sends a high level signal to the PIN8, it indicates that the optical signal is lost. If the MCU 312 sends a low level signal to the PIN8, it indicates that the optical signal is not lost.

By way of example, when the register value of the function configuration register is the sixth register value, and the status register stores the first status register value, the MCU 312 sends a high level signal to the PIN8, and the link of the network port terminal can be determined to be disconnected based on this level signal.

When the register value of the function configuration register is the sixth register value, and the status register stores the second status register value, the MCU 312 sends a low level signal to the PIN8, and the link of the network port terminal can be determined to be connected based on this level signal.

When the register value of the function configuration register is the sixth register value, and the status register stores the third status register value, the MCU 312 sends high-low transitions to the PIN8, and the data interaction can be determined at the network port terminal based on the level signal.

By way of example, when the register value of the function configuration register is the seventh register value, and the status register stores the first status register value, the MCU 312 sends a high level signal to the PIN8. Based on this level signal, it can be determined that the optical signal is lost and the link of the network port terminal is disconnected.

In some embodiments, when the register value of the function configuration register is the seventh register value, and the status register stores the second status register value, the MCU 312 sends a low level signal to the PIN8. Based on this level signal, it can be determined that the optical signal is not lost and the link of the network port terminal is connected.

In some embodiments, when the register value of the function configuration register is the seventh register value, and the status register stores the third status register value, the MCU 312 sends high-low transitions to the PIN8. Based on this level signal, it can be determined that the optical signal is not lost and that there is data interaction at the network port terminal.

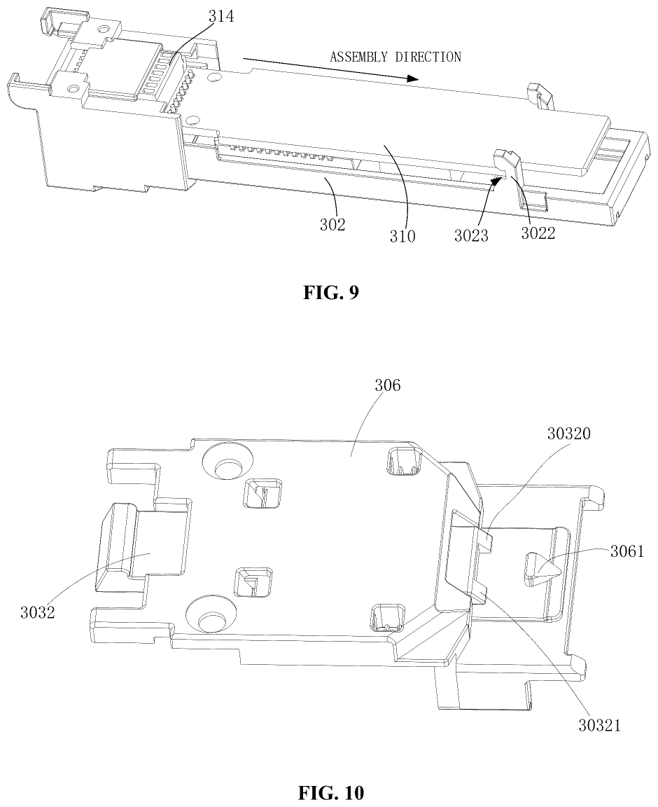

FIG. 8 is a structural schematic diagram of the lower shell part in an electrical interface module according to some embodiments of the present disclosure, and FIG. 9 is an assembly schematic diagram of a lower shell part, a circuit board and a network port terminal in an electrical interface module according to some embodiments of the present disclosure. As shown in FIG. 8 and FIG. 9, one end of the lower shell part 302 is provided with a fixing cavity 3021, and the fixing cavity 3021 is configured to accommodate the network port terminal 314. The network port terminal 314 is inserted into the fixing cavity 3021 from one end of the lower shell part 302 and secured within the fixing cavity 3021 by the unlocking component 303.

The other end of the fixing cavity 3021 is respectively provided with a support card holder 3022 on opposite sides, and the support card holder 3022 is configured to support and fix the circuit board 310, so as to facilitate the assembly and fixation of the circuit board 310. In some embodiments, a support card slot 3023 is arranged on the support card holder 3022, and the opening of the support card slot 3023 is oriented towards the fixing cavity 3021.

One end of the circuit board 310, where the gold finger 311 is located, is respectively provided with a notch 315 on opposite sides. The notch 315 is configured to engage with the support card slot 3023 on the support card holder 3022, which is used for the limiting fixation of the circuit board 310, so as to facilitate the fixation of the circuit board 310 in the lower shell part 302.

In some embodiments, during assembly of the electrical interface module, after soldering and mounting the MCU 312, the PHY chip 313 and the network port terminal 314 onto the circuit board 310, the circuit board 310 is inserted from one end of the lower shell part 302 until the notch 315 on the circuit board 310 is engaged with the support card slot 3023. The unlocking component 303 and the upper shell part 301 are then assembled. This assembly method facilitates the installation of the circuit board 310 into the lower shell part 302, thereby improving the assembly efficiency of the electrical interface module 300.

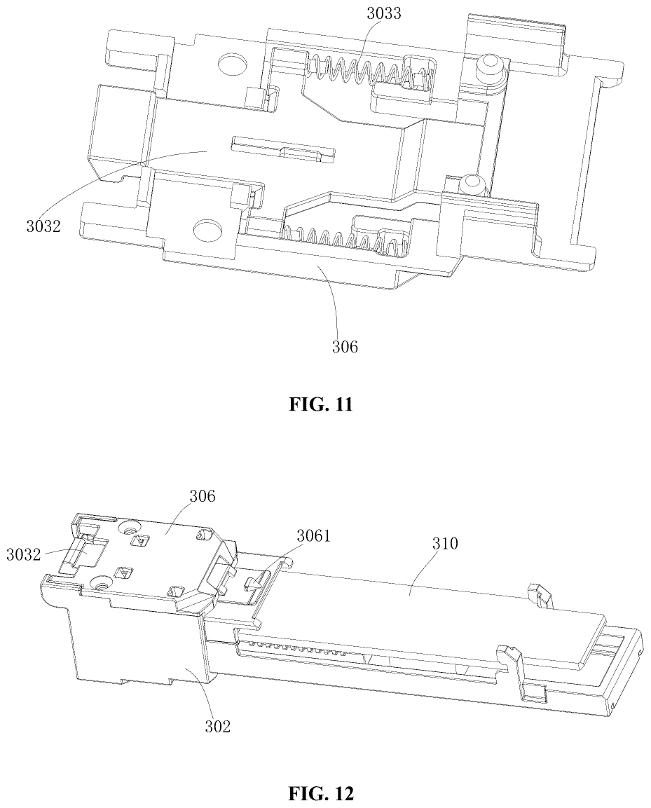

FIG. 10 is a first assembly schematic diagram of a cover plate and an unlocker in an electrical interface module according to some embodiments of the present disclosure, and FIG. 11 is a second assembly schematic diagram of a cover plate and an unlocker in an electrical interface module according to some embodiments of the present disclosure. As shown in FIG. 10 and FIG. 11, the upper shell part 301 comprises a cover plate 306, and the cover plate 306 comprises a first supporting plate and a second supporting plate. The first supporting plate is fixedly connected with the second supporting plate through a connecting plate. The connecting plate is obliquely arranged along the left-right direction, that is, the top surface of the first supporting plate protrudes beyond the top surface of the second supporting plate. The connecting plate is provided with a through hole, and the inner wall of the first supporting plate is communicated with the top surface of the second supporting plate through the through hole.

A positioning protrusion 3061 is arranged on the top surface of the second supporting plate. The positioning protrusion 3061 is a wedge protrusion on the top surface of the second supporting plate, and is an inactive part. The positioning protrusion is arranged opposite to the spring-lock hole on the cage of the host computer, and when the spring-lock hole cover engages with the positioning protrusion 3061, the electrical interface module 300 and the cage are mutually locked, and it is not easy to get out of lock.

The unlocking component 303 comprises a handle 3031 and an unlocker 3032, the unlocker 3032 is arranged on the inner side of the cover plate 306, one end of the unlocker 3032 passes through the through hole to be positioned on the top surface of the second support plate, and the unlocker 3032 can move left and right on the inner side of the cover plate 306. When the unlocker 3032 moves to the right, the unlocker 3032 can displace the spring plate on the cage, so that the cage is disengaged from the positioning protrusion 3061, thereby achieving disengagement between the electrical interface module 300 and the cage.

One end of the unlocker 3032 is provided with a first wedge block 30320 and a second wedge block 30321. The first wedge block 30320 and the second wedge block 30321 extend from the right side of the unlocker 3032 to the right. Along the left-to-right direction, the height dimensions of the first wedge block 30320 and the second wedge block 30321 in the up-down direction gradually decrease. There is a gap between the first wedge block 30320 and the second wedge block 30321, and the gap is arranged aligned with the positioning protrusion 3061.

In some embodiments, the distance between the first wedge block 30320 and the second wedge block 30321 is greater than the locking surface (i.e., the maximum width) of the positioning protrusion 3061, so that when the unlocker 3032 moves to the right to the positioning protrusion 3061, the first wedge block 30320 and the second wedge block 30321 can clear the positioning protrusion 3061 and extend out to the right. The inclined surfaces of the upper side of the first wedge block 30320 and the second wedge block 30321 are utilized to displace the spring lock hole on the cage from the positioning protrusion 3061, so that the cage is disengaged from the positioning protrusion 3061, thereby the disengagement is completed when the unlocker 3032 slides to the right.

The unlocking component 303 further comprises a return spring 3033. One end of the return spring 3033 is connected to the cover plate 306, and the other end of the return spring 3033 is connected to the unlocker 3032, so that the return spring 3033 is not easy to loosen. When the unlocking component 303 is in an unlocked state, the unlocker 3032 can automatically rebound under the action of the return spring 3033.

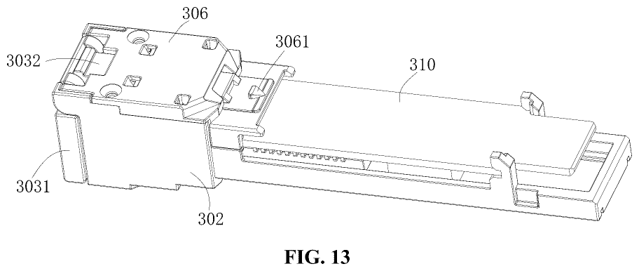

FIG. 12 is an assembly schematic diagram of a lower shell part, a circuit board, a cover plate and an unlocker in an electrical interface module according to some embodiments of the present disclosure, and FIG. 13 is an assembly schematic diagram of a lower shell part, a circuit board, a cover plate, an unlocker and a handle of an electrical interface module according to some embodiments of the present disclosure. As shown in FIG. 12 and FIG. 13, the circuit board 310 and the network port terminal 314 are assembled as a unit. After assembling the unit to the lower shell part 302 along the assembly direction (left-to-right), the cover plate 306 and the unlocker 3032 are mounted onto the lower shell part 302, and then the handle 3031 is installed at the fixing cavity 3021 of the lower shell part 302, so that the handle 3031 can rotate on the left side of the fixing cavity 3021, and the force application portion of the handle 3031 is in close contact with the force bearing portion of the unlocker 3032. Finally, the cover plate 306 is fixedly connected to the lower shell part 302 through a locking screw.

When the handle 3031 is in a vertical state, the electrical interface module 300 is in a locked state, and the return spring 3033 is compressed. The force bearing portion of the unlocker 3032 abuts against the unlocking surface of the handle 3031, ensuring that the unlocker 3032 and the handle 3031 are not loosened, and the distance between the extended side of the unlocker 3032 and the positioning protrusion 3061 satisfies the requirements.

To unlock the electrical interface module 300, the user grips the handle 3031 and rotates it upward from the bottom, and the unlocking surface of the handle 3031 abuts against the force bearing portion of the unlocker 3032, making the unlocker 3032 move to the right. When the handle 3031 is in a horizontal state, one end of the unlocker 3032 moves rightward to the through hole, the first wedge block 30320 and the second wedge block 30321 move rightward to the positioning protrusion 3061, and the first wedge block 30320 and the second wedge block 30321 displace the spring-lock hole on the cage, making the cage detach from the positioning protrusion 3061, thereby unlocking the electrical interface module 300. When the electrical interface module 300 is in an unlocked state, pulling the handle 3031 outward enables smooth extraction of the electrical interface module 300 from the cage.

When the user releases the handle 3031, since the return spring 3033 is in a tensioned state, under the restoring force of the return spring 3033, the unlocker 3032 moves leftward and simultaneously pulls the handle 3031 to rotate from top to bottom, so that the handle 3031 realizes automatic reset.

In some embodiments, during assembly of the electrical interface module, after soldering and mounting the MCU, the PHY chip and the network port terminal onto the circuit board 310, the circuit board is inserted from one end of the lower shell part until the notch on the circuit board is engaged with the support card slot on the lower shell part. Then the unlocker is mounted onto the cover plate, wherein the unlocker can move left and right on the cover plate, and the unlocker and the cover plate are assembled onto the lower shell part. Subsequently, the handle is arranged to the lower shell part, so that the handle rotates on the lower shell part, and the rotation of the handle can make the unlocker move left and right on the cover plate, so as to realize the assembly of the electrical interface module.

In the embodiments of the present disclosure, the function configuration register is utilized to reconfigure the PIN8 by assigning new functions to the PIN8, so that it has a network port status indication function, or has both the RX_LOS function and the network port status indication function, wherein the link status of the network port terminal can be monitored according to the level state of the PIN8, and the normal operation of the electrical interface module 300 is ensured.

Finally, it should be noted that the above embodiments are only used to illustrate the technical solutions of the present disclosure, rather than to limit them. Although the present disclosure has been described in detail with reference to the aforementioned embodiments, those skilled in the art should understand that they can still modify the technical solutions described in the aforementioned embodiments, or make equivalent replacements for some of the technical features therein. Such modifications or replacements shall not cause the essence of the corresponding technical solutions to depart from the spirit and scope defined by the technical solutions of the embodiments of the present disclosure.

What is claimed is:

1. An electrical interface module, comprising:
a circuit board, one end of the circuit board being disposed with a gold finger, and the gold finger comprising an I2C pin and a multiplexed pin;
a network port terminal electrically connected to the circuit board and configured to transmit a signal via a network cable;
a PHY chip arranged on the circuit board and comprising a status register, the status register being configured to store a status register value corresponding to a link status of the network port terminal; and
an MCU arranged on the circuit board, wherein one end of the MCU is connected to the I2C pin and the multiplexed pin, and can receive a command from a host device through the I2C pin; the other end of the MCU is connected to the PHY chip; and the MCU comprises therein with a function configuration register configured to store a register value corresponding to the command from the host device; and
the MCU is configured to perform corresponding function configuration on the multiplexed pin based on the register value from the function configuration register, and in a case that the multiplexed pin has a network port status indication function, send a corresponding level signal to the multiplexed pin by accessing and obtaining the status register value, so as to obtain the link status of the network port terminal based on the level signal; or, in a case that the multiplexed pin has both an RX_LOS function and the network port status indication function, send a corresponding level signal to the multiplexed pin by accessing and obtaining the status register value, so as to obtain an RX_LOS state of a received signal and the link status of the network port terminal based on the level signal.

2. The electrical interface module according to claim 1, wherein the function configuration register comprises a first register, and a register value of the first register comprises a first register value and a second register value; and
the MCU is configured to perform function configuration on the multiplexed pin based on the first register value such that the multiplexed pin has the RX_LOS function; and
is configured to perform function configuration on the multiplexed pin based on the second register value such that the multiplexed pin has the network port status indication function.

3. The electrical interface module according to claim 2, wherein the function configuration register further comprises a second register, and a register value of the second register comprises a third register value and a fourth register value; and
the MCU is configured to perform function configuration on the multiplexed pin based on the third register value such that the multiplexed pin has the RX_LOS function; and
is configured to perform function configuration on the multiplexed pin based on the fourth register value such that the multiplexed pin has both the RX_LOS function and the network port status indication function.

4. The electrical interface module according to claim 3, wherein the status register stores a first status register value, a second status register value or a third status register value, wherein
the first status register value indicates that a link of the network port terminal is disconnected;
the second status register value indicates that the link of the network port terminal is connected; and
the third status register value indicates that there is data interaction at the network port terminal.

5. The electrical interface module according to claim 4, wherein in a case that the register value of the first register is the second register value, and the status register stores the first status register value, the MCU sends a first level signal to the multiplexed pin based on the first status register value;
in a case that the register value of the first register is the second register value, and the status register stores the second status register value, the MCU sends a second level signal to the multiplexed pin based on the second status register value;
in a case that the register value of the first register is the second register value, and the status register stores the third status register value, the MCU sends a third level signal to the multiplexed pin based on the third status register value.

6. The electrical interface module according to claim 5, wherein the first level signal is a high level signal, the second level signal is a low level signal, and the third level signal is a high-low transition pulse; and
a level value of the first level signal is greater than a level value of the second level signal, and the level value of the first level signal is greater than a level value of the third level signal.

7. The electrical interface module according to claim 4, wherein in a case that the register value of the second register is the fourth register value, and the status register stores the first status register value, the MCU sends a fourth level signal to the multiplexed pin based on the first status register value;
in a case that the register value of the second register is the fourth register value, and the status register stores the second status register value, the MCU sends a fifth level signal to the multiplexed pin based on the second status register value;
in a case that the register value of the second register is the fourth register value, and the status register stores the third status register value, the MCU sends a sixth level signal to the multiplexed pin based on the third status register value.

8. The electrical interface module according to claim 7, wherein the fourth level signal is a high level signal, the fifth level signal is a low level signal, and the sixth level signal is a high-low transition pulse; and
a level value of the fourth level signal is greater than a level value of the fifth level signal, and the level value of the fourth level signal is greater than a level value of the sixth level signal.

9. The electrical interface module according to claim 8, wherein in the case that the multiplexed pin has both the network port status indication function and the RX_LOS function of the received signal: if a level signal of the multiplexed pin is the fourth level signal, the link of the network port terminal is disconnected, and the received signal is in a loss-of-signal condition;
if the level signal of the multiplexed pin is the fifth level signal, the link of the network port terminal is connected, and the received signal is not in the loss-of-signal condition;
if the level signal of the multiplexed pin is the sixth level signal, there is data interaction at the network port terminal, and the received signal is not in the loss-of-signal condition.

10. The electrical interface module according to claim 1, wherein the register value of the function configuration register comprises a fifth register value, a sixth register value and a seventh register value; and
the MCU is configured to perform function configuration on the multiplexed pin based on the fifth register value such that the multiplexed pin has the RX_LOS function;
is configured to perform function configuration on the multiplexed pin based on the sixth register value such that the multiplexed pin has the network port status indication function; is configured to perform function configuration on the multiplexed pin based on the seventh register value such that the multiplexed pin has both the RX_LOS function and the network port status indication function.

11. The electrical interface module according to claim 4, wherein an LED light is arranged on a wiring connecting the MCU and the multiplexed pin; and
the MCU is configured to control a display state of the LED light according to the status register value stored in the status register, and then obtain the link status of the network port terminal according to the display state of the LED light.

12. The electrical interface module according to claim 11, wherein if the status register stores the first status register value, the MCU controls the display state of the LED light to be a first state according to the first status register value;
if the status register stores the second status register value, the MCU controls the display state of the LED light to be a second state according to the second status register value;
if the status register stores the third status register value, the MCU controls the display state of the LED light to be a third state according to the third status register value.

13. The electrical interface module according to claim 12, wherein the first state of the LED light is off, the second state of the LED light is on, and the third state of the LED light is flashing.

14. The electrical interface module according to claim 1, wherein the multiplexed pin is a PIN8 pin.

15. An electrical interface module, comprising:
a circuit board, one end of the circuit board being disposed with a gold finger, and the gold finger comprising an I2C pin and a multiplexed pin;
a network port terminal electrically connected to the circuit board and configured to transmit a signal via a network cable;
a PHY chip arranged on the circuit board and comprising a status register, the status register being configured to store a status register value corresponding to a link status of the network port terminal; and
an MCU arranged on the circuit board, wherein one end of the MCU is connected to the I2C pin and the multiplexed pin, and can receive a command from a host device through the I2C pin;
the other end of the MCU is connected to the PHY chip, and is configured to access and obtain the status register value and send a corresponding level signal to the multiplexed pin based on the status register value;
wherein the MCU comprises therein with a second register that is configured to store a register value corresponding to the command from the host device, and the MCU is configured to perform corresponding function configuration on the multiplexed pin based on the register value such that the multiplexed pin has both an RX_LOS function of a received signal and a network port status indication function, and obtain, according to the level signal of the multiplexed pin, the link status of the network port terminal and the RX_LOS state of the received signal in a case that the multiplexed pin has both the RX_LOS function of the received signal and the network port status indication function; wherein, the second register stores a third register value and a fourth register value, and the MCU configures the multiplexed pin as an RX_LOS pin according to the third register value, and configures the multiplexed pin as an RX_LOS pin and an network port status indication pin according to the fourth register value.

16. The electrical interface module according to claim 15, wherein the status register stores a first status register value, a second status register value or a third status register value, and wherein the first status register value is used to indicate that a link of the network port terminal is disconnected, the second status register value is used to indicate that the link of the network port terminal is connected, and the third status register value is used to indicate that there is data interaction at the network port terminal.

17. The electrical interface module according to claim 16, wherein if the status register stores the first status register value, the MCU sends a fourth level signal to the multiplexed pin according to the first status register value;
if the status register stores the second status register value, the MCU sends a fifth level signal to the multiplexed pin according to the second status register value;
if the status register stores the third status register value, the MCU sends a sixth level signal to the multiplexed pin according to the third status register value.

18. The electrical interface module according to claim 17, wherein the fourth level signal is a high level signal, the fifth level signal is a low level signal, and the sixth level signal is a high-low transition pulse; and
a level value of the fourth level signal is greater than a level value of the fifth level signal, and the level value of the fourth level signal is greater than a level value of the sixth level signal.

19. The electrical interface module according to claim 18, wherein in the case that the multiplexed pin has both the RX_LOS function of the received signal and the network port status indication function, if the level signal of the multiplexed pin is the fourth level signal, the link of the network port terminal is disconnected and the received signal is in a loss-of-signal condition;
if the level signal of the multiplexed pin is the fifth level signal, the link of the network port terminal is connected, and the received signal is not in the loss-of-signal condition;
if the level signal of the multiplexed pin is the sixth level signal, there is data interaction at the network port terminal, and the received signal is not in the loss-of-signal condition.

20. The electrical interface module according to claim 16, wherein an LED light is arranged on a wiring connecting the MCU and the multiplexed pin, and the MCU controls a display state of the LED light according to the status register value stored in the status register, so as to obtain the link status of the network port terminal and the RX_LOS state of the received signal according to the display state of the LED light.
